(19) United States
(12) Patent Application Publication
(10) Pub. No.: US 2022/0077474 A1
(43) Pub. Date: Mar. 10, 2022

(54) METHOD FOR FORMING FLOW CHANNEL ON METAL BIPOLAR PLATE OF FUEL CELL

(71) Applicant: Taiyuan University of Science and Technology, Taiyuan (CN)

(72) Inventors: Fuqiang ZHAO, Taiyuan (CN); Zhiying GAO, Taiyuan (CN); Qingxue HUANG, Taiyuan (CN); Huiqing QI, Taiyuan (CN); Hongwei WANG, Taiyuan (CN)

(21) Appl. No.: 17/530,063

(22) Filed: Nov. 18, 2021

Related U.S. Application Data
(63) Continuation of application No. PCT/CN2020/111920, filed on Aug. 27, 2020.

(30) Foreign Application Priority Data
Sep. 5, 2019 (CN) 201910834814.8

(51) Int. Cl. H01M 8/026; H01M 8/0206

(52) U.S. Cl. CPC H01M 8/026; H01M 8/0206

(57) ABSTRACT

A method for forming a flow channel on a metal bipolar plate of a fuel cell includes: pre-treating a metal polar plate; subjecting the metal polar plate to low-temperature heating; forming a flow channel on the metal polar plate by rolling; cutting an inlet and outlet for gas and cooling liquid on the metal polar plate; performing surface treatment on the metal polar plate; bonding two metal polar plates to form a metal bipolar plate; and trimming the metal bipolar plate. The flow channel is formed by two pre-forming and one truing, and design parameters of punches and dies of the rollers used are determined by calculation models.

### CROSS-REFERENCE TO RELATED APPLICATIONS

This application is a continuation of International Patent Application No. PCT/CN2020/111920, filed on Aug. 27, 2020, which claims the benefit of priority from Chinese Patent Application No. 201910834814.8, filed on Sep. 5, 2019. The content of the aforementioned applications, including any intervening amendments thereto, is incorporated herein by reference in its entirety.

### TECHNICAL FIELD

The present disclosure relates to production of polar plates of fuel cells, and more particularly to a method for forming a flow channel on a metal bipolar plate of a fuel cell.

### BACKGROUND

Bipolar plate is a vital component of a fuel cell, and is mainly made of metal, graphite or composite material. The graphite bipolar plate has advantages of low density and great corrosion resistance. Unfortunately, a low porosity, low mechanical strength and high brittleness of graphite result in a large volume and mass of the graphite bipolar plate. Moreover, the composite bipolar plate has large contact resistance and high cost. By comparison, the metal bipolar plate has advantages of great electrical conductivity, corrosion resistance and processability. Whereas, the current stamping process fails to enable the continuous production of metal bipolar plates, and it also struggles with high machining power, imprecise machining shape and large difficulties in controlling warpage and rebound. In view of this, it is necessary to provide a novel method for manufacturing a metal bipolar plate to realize high-precision batch production, as well as increase the flow channel depth and reduce the thickness change of the metal bipolar plate after forming.

### SUMMARY

An object of the present disclosure is to provide a method for forming a flow channel on a metal bipolar plate of a fuel cell to overcome the defects in the prior art, in which a shape design model of a roller used in the rolling of a metal bipolar plate of a fuel cell by two pre-forming and one truing. The forming method with two pre-forming and one truing increases the flow channel depth and reduces the thickness change of the metal bipolar plate after forming. Moreover, it has efficient and simple operation, and is suitable for the continuous production of the metal bipolar plate of a fuel cell.

The technical solutions of the present disclosure are described as follows.

The disclosure provides a method for forming a flow channel on a metal bipolar plate of a fuel cell, comprising:

pre-treating a metal polar plate;

subjecting the metal polar plate to low-temperature heating;

forming a flow channel on the metal polar plate by rolling;

cutting a gas inlet, a gas outlet, a cooling liquid inlet and a cooling liquid outlet on the metal polar plate;

subjecting the metal polar plate to surface treatment;

bonding the metal polar plate with another metal polar plate treated by the above steps to form a metal bipolar plate; and

trimming the metal bipolar plate;

wherein the step of “forming a flow channel on the metal polar plate by rolling” is performed through steps of:

performing pre-forming twice on the metal polar plate sequentially using a pair of first rollers and a pair of second rollers; and

performing truing once using a pair of truing rollers to form the flow channel on the metal polar plate;

design parameters of a first punch and a first die of each of the pair of first rollers used in a first pre-forming and design parameters of a second punch and a second die of each of the pair of second rollers used in a second pre-forming are determined through the following steps:

(1) determining an inclination length l₁₁, a draft angle β₁₁ and a depth h₁₁ of the first punch by a first calculation model:

$$\{ \begin{matrix}{l}_{11} = ( {r}_{11} + {k}_{1} t ) tan \frac{{α}_{11}}{2} \\ {β}_{11} = 90 ° - {α}_{11} \\ {h}_{11} = {r}_{11} ( 1 - cos {α}_{11} ) + ( {r}_{11} + {k}_{1} t ) tan \frac{{α}_{11}}{2} \times sin {α}_{11}\end{matrix} ;$$

wherein r₁₁ is an arc radius of the first punch; α₁₁ is half of an arc included angle of the first punch; t is a thickness of the metal polar plate; and k₁ is a ratio of a thickness of the metal polar plate after the first pre-forming to a thickness of the metal polar plate before the first pre-forming, and 0<k₁<1; and determining an inclination length l₁₂, a draft angle β₁₂, a depth h₁₂ and a horizontal length l₁ of the first die by a second calculation model:

$$\{ \begin{matrix}{l}_{12} = ( {r}_{12} + {k}_{1} t ) tan \frac{{α}_{12}}{2} \\ {β}_{12} = 90 ° - {α}_{12} \\ {h}_{12} = {r}_{12} ( 1 - cos {α}_{12} ) + ( {r}_{12} + {k}_{1} t ) tan \frac{{α}_{12}}{2} \times sin {α}_{12} \\ {l}_{1} = 2 ( {r}_{12} + {k}_{1} t ) tan \frac{{α}_{12}}{2}\end{matrix} ;$$

wherein r₁₂ is an arc radius of the first die; α₁₂ is an arc included angle of the first die; t is the thickness of the metal polar plate; and k₁ is the ratio of the thickness of the metal polar plate after the first pre-forming to the thickness of the metal polar plate before the first pre-forming, and 0<k₁<1; and

(2) determining an inclination length l₂₁, an arc radius r₂₁, a draft angle β₂₁ and a depth h₂₁ of the second punch by a third calculation model:

$$\{ \begin{matrix}{r}_{21} = \frac{{k}_{1} {α}_{11}}{{k}_{2} {α}_{21}} \times ( {r}_{11} + \frac{{k}_{1} t}{2} ) - \frac{{k}_{2} t}{2} \\ {l}_{21} = ( {r}_{21} + {k}_{2} t ) tan \frac{{α}_{21}}{2} \\ {β}_{21} = 90 ° - {α}_{21} \\ {h}_{21} = {r}_{21} ( 1 - cos {α}_{21} ) + ( {r}_{21} + {k}_{2} t ) tan \frac{{α}_{21}}{2} \times sin {α}_{21}\end{matrix} ;$$

wherein r₁₁ is the arc radius of the first punch; α₁₁ is half of the arc included angle of the first punch; α₂₁ is half of an arc included angle of the second punch; t is the thickness of the metal polar plate; k₁ is the ratio of the thickness of the metal polar plate after the first pre-forming to the thickness of the metal polar plate before the first pre-forming, and 0<k₁<1; and k₂ is a ratio of a thickness of the metal polar plate after the second pre-forming to the thickness of the metal polar plate after the first pre-forming, and 0<k₂<1; and

determining an inclination length l₂₂, an arc radius r₂₂, a draft angle β₂₂, a depth h₂₂ and a horizontal length l₁ of the second die by a fourth calculation model:

$$\{ \begin{matrix}{r}_{22} = \frac{{k}_{1} {α}_{12}}{{k}_{2} {α}_{22}} \times ( {r}_{12} + \frac{{k}_{1} t}{2} ) - \frac{{k}_{2} t}{2} \\ {l}_{22} = ( {r}_{22} + {k}_{2} t ) tan \frac{{α}_{22}}{2} \\ {β}_{22} = 90 ° - {α}_{22} \\ {h}_{22} = {r}_{22} ( 1 - cos {α}_{22} ) + ( {r}_{22} + {k}_{2} t ) tan \frac{{α}_{22}}{2} \times sin {α}_{22} \\ {l}_{2} = 2 ( {r}_{22} + {k}_{2} t ) tan \frac{{α}_{22}}{2}\end{matrix} ;$$

wherein r₁₂ is the arc radius of the first die; α₁₂ is the arc included angle of the first die; α₂₂ is an arc included angle of the second die; t is the thickness of the metal polar plate; k₁ is the ratio of the thickness of the metal polar plate after the first pre-forming to the thickness of the metal polar plate before the first pre-forming, and 0<k₁<1; and k₂ is the ratio of the thickness of the metal polar plate after the second pre-forming to the thickness of the metal polar plate after the first pre-forming, and 0<k₂<1.

In some embodiments, design parameters of a third punch and a third die of each of the pair of truing rollers are determined through the following steps:

determining an inclination length l₃₁, an arc radius r₃₁, a draft angle β₃₁ and a depth h₃₁ of the third punch by a fifth calculation model:

$$\{ \begin{matrix}{r}_{31} = \frac{{r}_{21} {k}_{2} {α}_{21}}{{k}_{3} {α}_{31}} + \frac{{k}_{2}^{2} t {α}_{21}}{2 {k}_{3} {α}_{31}} - \frac{90 ° ( s + c )}{π {α}_{31}} - \frac{{k}_{3} t}{2} \\ {l}_{31} = ( {r}_{31} + {k}_{3} t ) tan \frac{{α}_{31}}{2} + s \\ {β}_{31} = 90 ° - {α}_{31} \\ {h}_{31} = {r}_{31} ( 1 - cos {α}_{31} ) + ( {r}_{31} + {k}_{3} t ) tan \frac{{α}_{31}}{2} \times sin {α}_{32} + s cos {β}_{31}\end{matrix} ;$$

wherein r₂₁ is the arc radius of the second punch; α₂₁ is half of the arc included angle of the second punch; α₃₁ is half of an arc included angle of the third punch; s is an inclination length of the third punch and the third die for elongating the metal polar plate; c is a horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is a ratio of a thickness of the metal polar plate after the truing to the thickness of the metal polar plate after the second pre-forming, and 0<k₃<1; and determining an inclination length l₃₂, an arc radius r₃₂, a draft angle β₃₂, a depth h₃₂ and a horizontal length l₃ of the third die by a sixth calculation model:

$$\{ \begin{matrix}{r}_{32} = \frac{{r}_{22} {k}_{2} {α}_{22}}{{k}_{3} {α}_{32}} + \frac{{k}_{2}^{2} t {α}_{22}}{2 {k}_{3} {α}_{32}} - \frac{90 ° ( s + c )}{π {α}_{32}} - \frac{{k}_{3} t}{2} \\ {l}_{32} = ( {r}_{32} + {k}_{3} t ) tan \frac{{α}_{32}}{2} + s \\ {β}_{32} = 90 ° - {α}_{32} \\ {h}_{32} = {r}_{32} ( 1 - cos {α}_{32} ) + ( {r}_{32} + {k}_{3} t ) tan \frac{{α}_{32}}{2} \times sin {α}_{32} + s cos {β}_{32} \\ {l}_{3} = 2 ( {r}_{31} + {k}_{3} t ) tan \frac{{α}_{31}}{2} + c\end{matrix} ;$$

wherein r₂₂ is the arc radius of the second die; α₂₂ is the arc included angle of the second die; α₃₂ is an arc included angle of the third die; s is the inclination length of the third punch and the third die for elongating the metal polar plate; c is the horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is the ratio of the thickness of the metal polar plate after the truing to the thickness of the metal polar plate after the second pre-forming, and 0<k₃<1.

In some embodiments, a model for calculating a depth h, a width d, a spine width w and a fillet angle r of the flow channel of the metal polar plate is shown as follows:

$$\{ \begin{matrix}r = \frac{{r}_{21} {k}_{2} {α}_{21}}{{k}_{3} {α}_{31}} + \frac{{k}_{2}^{2} t {α}_{21}}{2 {k}_{3} {α}_{31}} - \frac{90 ° ( s + c )}{π {α}_{31}} - \frac{{k}_{3} t}{2} \\ h = r ( 1 - cos {α}_{31} ) + ( r + {k}_{3} t ) tan \frac{{α}_{31}}{2} \times sin {α}_{32} + s cos {β}_{31} \\ w = 2 ( r + {k}_{3} t ) sin {α}_{31} + c \\ d = 2 s sin {β}_{31} + 2 r sin {α}_{31} + c\end{matrix} ;$$

wherein r₂₁ is the arc radius of the second punch; α₂₁ is half of the arc included angle of the second punch; α₃₁ is half of an arc included angle of a punch of each of the pair of truing rollers; s is an inclination length of the punch and a die of each of the pair of truing rollers for elongating the metal polar plate; c is a horizontal length of the punch and the die of each of the pair of truing rollers for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is a ratio of a thickness of the metal polar plate after the truing to the thickness of the metal polar plate after the second pre-forming, and 0<k₃<1.

Compared to the prior art, the disclosure has the following beneficial effects.

In the method provided herein, the flow channels are formed on the metal bipolar plate by means of two pre-forming processes and one truing process. As a consequence, the method of the disclosure can realize the continuous production, and in the method, the machining power is significantly reduced, the rebound and warpage can be effectively controlled. In addition, models for calculating the design parameters of the rollers used in the pre-forming and truing are also provided herein, which facilitates the manufacture of the rollers, rendering the flow channels manufactured by roll forming superior to those manufactured by micro-stamping forming in the quality and precision, so as to improve a power density of the fuel cell and promote the installation of a fuel cell stack.

### BRIEF DESCRIPTION OF THE DRAWINGS

FIG. 1 is a flow chart of a method for forming a flow channel on a metal bipolar plate according to an embodiment of the present disclosure;

FIG. 2 schematically depicts parameters of a punch and a die of a roller used in the first pre-forming process;

FIG. 3 schematically depicts parameters of a punch and a die of a roller used in the second pre-forming process;

FIG. 4 schematically depicts parameters of a punch and a die of a roller used in the truing process;

FIG. 5 schematically depicts the first pre-forming process;

FIG. 6 schematically depicts the second pre-forming process;

FIG. 7 schematically depicts the flow channels on the metal polar plate of the present disclosure after the second pre-forming process;

FIG. 8 schematically depicts the truing of the flow channels of the metal polar plate of the present disclosure; and

FIG. 9 schematically depicts the formed flow channels of the metal polar plate of the present disclosure.

In the drawings, 1, straightening and feeding metal polar plate; 2, thinning the metal polar plate; 3, straightening the metal polar plate; 4; cleaning the metal polar plate; 5, detecting thickness of the metal polar plate; 6, low-temperature heating the metal polar plate; 7, rolling the metal polar plate; 8, cutting the metal polar plate; 9, performing surface treatment on the metal polar plate; 10, bonding two metal polar plates to form a metal bipolar plate; and 11, trimming the metal bipolar plate.

### DETAILED DESCRIPTION OF EMBODIMENTS

The disclosure will be clearly described below with reference to the accompanying drawings and embodiments.

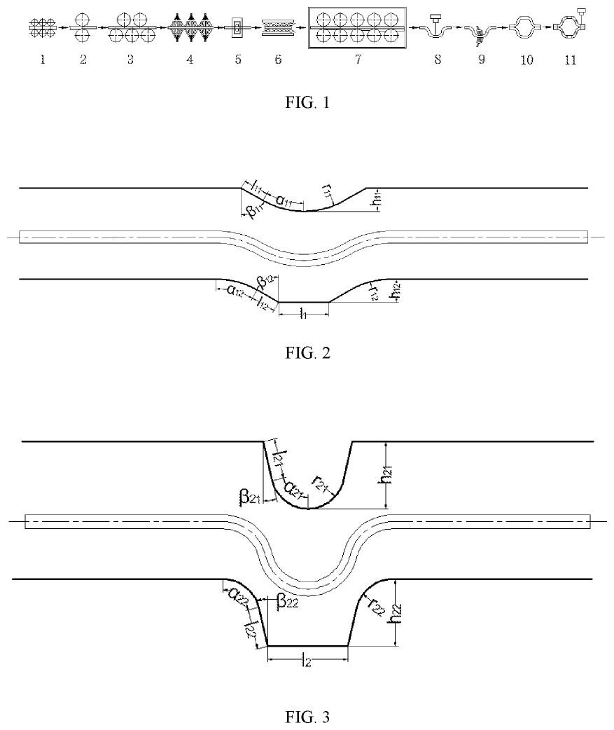

As shown in FIG. 1, an embodiment of the disclosure provides a method for forming a flow channel on a metal bipolar plate of a fuel cell, which includes: (1) straightening and feeding metal polar plate; (2) thinning the metal polar plate; (3) straightening the metal polar plate; (4) cleaning the metal polar plate; (5) detecting thickness of the metal polar plate; (6) low-temperature heating the metal polar plate; (7) rolling the metal polar plate in an insulation device; (8) cutting the metal polar plate; (9) performing surface treatment on the metal polar plate; (10) bonding two metal polar plates to form a metal bipolar plate; and (11) trimming the metal bipolar plate.

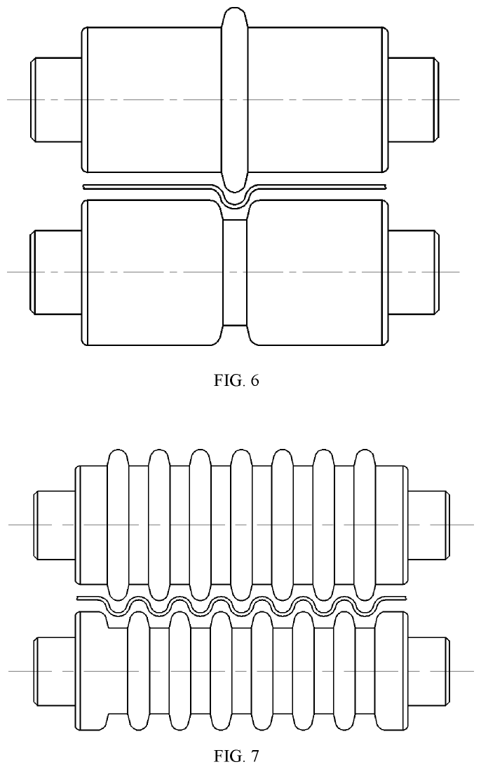

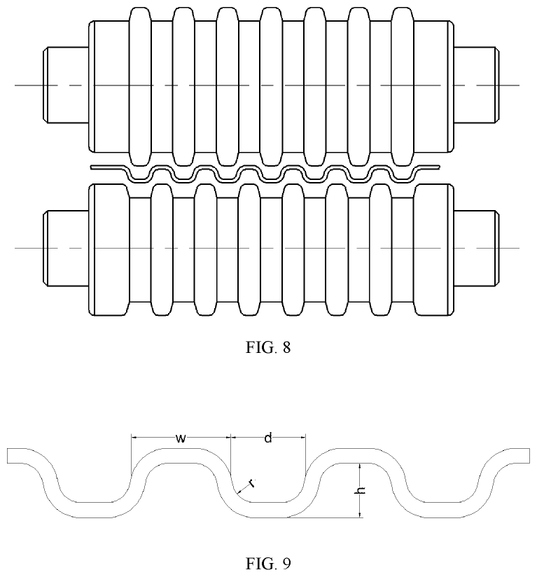

As show in FIGS. 5-8, the metal polar plate is rolled from a middle of a width of the metal polar plate to two sides thereof to form flow channels, and a flow channel is formed by two pre-forming and one truing. The first pre-forming is performed for a first flow channel in center line of the metal polar plate by a first pair of rollers. The second pre-forming is performed on the first flow channel by a second pair of rollers, meanwhile, the first pre-forming is performed for second flow channels at a symmetrical position of the first flow channel on left and right equidistance. The second pre-forming is performed on the second flow channels by a third pair of rollers, meanwhile, the first pre-forming is performed for third flow channels at a symmetrical position of the first flow channel on twice the left and right equidistance, and so on. As a consequence, all of the low channels of the metal polar plate are performed two pre-formed. After the above steps, a truing is performed to all of the low channels by a pair of truing rollers to form the flow channel on the metal polar plate.

As shown in FIGS. 2 and 3, design parameters of a first punch and a first die of each first roller used in a first pre-forming and design parameters of a second punch and a second die of each second roller used in a second pre-forming are determined through the following steps.

(1) An inclination length l₁₁, a draft angle β₁₁ and a depth h₁₁ of the first punch are determined by a first calculation model:

$$\{ \begin{matrix}{l}_{11} = ( {r}_{11} + {k}_{1} t ) tan \frac{{α}_{11}}{2} \\ {β}_{11} = 90 ° - {α}_{11} \\ {h}_{11} = {r}_{11} ( 1 - cos {α}_{11} ) + ( {r}_{11} + {k}_{1} t ) tan \frac{{α}_{11}}{2} \times sin {α}_{11}\end{matrix} ;$$

where r₁₁ is an arc radius of the first punch; α₁₁ is half of an arc included angle of the first punch; t is a thickness of the metal polar plate; and k₁ is a ratio of a thickness of the metal polar plate after the first pre-forming to a thickness of the metal polar plate before the first pre-forming, and 0<k₁<1.

An inclination length l₁₂, a draft angle β₁₂, a depth h₁₂ and a horizontal length l₁ of the first die are determined by a second calculation model:

$$\{ \begin{matrix}{l}_{12} = ( {r}_{12} + {k}_{1} t ) tan \frac{{α}_{12}}{2} \\ {β}_{12} = 90 ° - {α}_{12} \\ {h}_{12} = {r}_{12} ( 1 - cos {α}_{12} ) + ( {r}_{12} + {k}_{1} t ) tan \frac{{α}_{12}}{2} \times sin {α}_{12} \\ {l}_{1} = 2 ( {r}_{12} + {k}_{1} t ) tan \frac{{α}_{12}}{2}\end{matrix} ;$$

where r₁₂ is an arc radius of the first die; α₁₂ is an arc included angle of the first die; t is the thickness of the metal polar plate; and k₁ is the ratio of the thickness of the metal polar plate after the first pre-forming to the thickness of the metal polar plate before the first pre-forming, and 0<k₁<1.

(2) An inclination length l₂₁, an arc radius r₂₁, a draft angle fill and a depth h₂₁ of the second punch are determined by a third calculation model:

$$\{ \begin{matrix}{r}_{21} = \frac{{k}_{1} {α}_{11}}{{k}_{2} {α}_{21}} \times ( {r}_{11} + \frac{{k}_{1} t}{2} ) - \frac{{k}_{2} t}{2} \\ {l}_{21} = ( {r}_{21} + {k}_{2} t ) tan \frac{{α}_{21}}{2} \\ {β}_{21} = 90 ° - {α}_{21} \\ {h}_{21} = {r}_{21} ( 1 - cos {α}_{21} ) + ( {r}_{21} + {k}_{2} t ) tan \frac{{α}_{21}}{2} \times sin {α}_{21}\end{matrix} ;$$

where r₁₁ is the arc radius of the first punch; α₁₁ is half of the arc included angle of the first punch; α₂₁ is half of an arc included angle of the second punch; t is the thickness of the metal polar plate; k₁ is the ratio of the thickness of the metal polar plate after the first pre-forming to the thickness of the metal polar plate before the first pre-forming, and 0<k₁<1; k₂ is a ratio of a thickness of the metal polar plate after the second pre-forming to the thickness of the metal polar plate after the first pre-forming, and 0<k₂<1.

An inclination length l₂₂, an arc radius r₂₂, a draft angle β₂₂, a depth h₂₂ and a horizontal length l₁ of the second die are determined by a fourth calculation model:

$$\{ \begin{matrix}{r}_{22} = \frac{{k}_{1} {α}_{12}}{{k}_{2} {α}_{22}} \times ( {r}_{12} + \frac{{k}_{1} t}{2} ) - \frac{{k}_{2} t}{2} \\ {l}_{22} = ( {r}_{22} + {k}_{2} t ) tan \frac{{α}_{22}}{2} \\ {β}_{22} = 90 ° - {α}_{22} \\ {h}_{22} = {r}_{22} ( 1 - cos {α}_{22} ) + ( {r}_{22} + {k}_{2} t ) tan \frac{{α}_{22}}{2} \times sin {α}_{22} \\ {l}_{2} = 2 ( {r}_{22} + {k}_{2} t ) tan \frac{{α}_{22}}{2}\end{matrix} ;$$

where r₁₂ is the arc radius of the first die. α₁₂ is the arc included angle of the first die; α₂₂ is an arc included angle of the second die; t is the thickness of the metal polar plate; k₁ is the ratio of the thickness of the metal polar plate after the first pre-forming to the thickness of the metal polar plate before the first pre-forming, and 0<k₁<1; k₂ is the ratio of the thickness of the metal polar plate after the second pre-forming to the thickness of the metal polar plate after the first pre-forming, and 0<k₂<1.

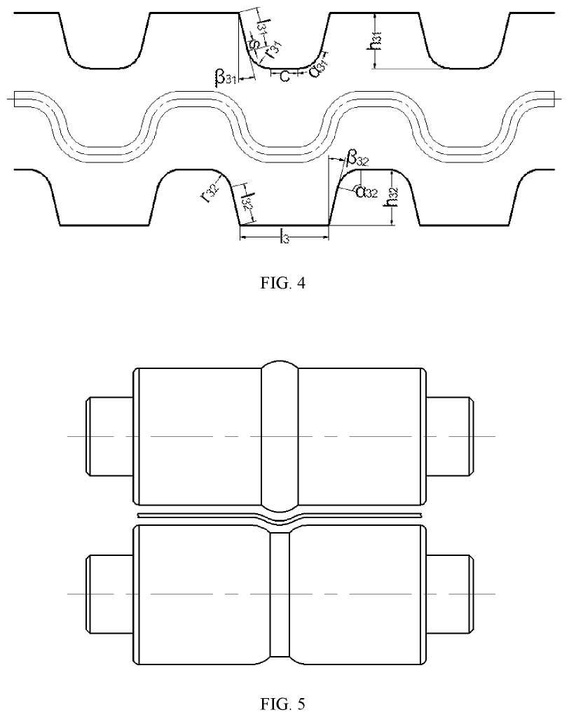

As shown in FIG. 4, design parameters of a third punch and a third die of each of the pair of truing rollers are determined through the following steps.

An inclination length l₃₁, an arc radius r₃₁, a draft angle β₃₁ and a depth h₃₁ of the third punch are determined by a fifth calculation model:

$$\{ \begin{matrix}{r}_{31} = \frac{{r}_{21} {k}_{2} {α}_{21}}{{k}_{3} {α}_{31}} + \frac{{k}_{2}^{2} t {α}_{21}}{2 {k}_{3} {α}_{31}} - \frac{90 ° ( s + c )}{π {α}_{31}} - \frac{{k}_{3} t}{2} \\ {l}_{31} = ( {r}_{31} + {k}_{3} t ) tan \frac{{α}_{31}}{2} + s \\ {β}_{31} = 90 ° - {α}_{31} \\ {h}_{31} = {r}_{31} ( 1 - cos {α}_{31} ) + ( {r}_{31} + {k}_{3} t ) tan \frac{{α}_{31}}{2} \times sin {α}_{32} + s cos {β}_{31}\end{matrix} ;$$

where r₂₁ is the arc radius of the second punch; α₂₁ is half of the arc included angle of the second punch; α₃₁ is half of an arc included angle of the third punch; s is an inclination length of the third punch and the third die for elongating the metal polar plate; c is a horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is a ratio of a thickness of the metal polar plate after the truing to the thickness of the metal polar plate after the second pre-forming, and 0<k₃<1.

An inclination length l₃₂, an arc radius r₃₂, a draft angle β₃₂, a depth h₃₂ and a horizontal length l₃ of the third die are determined by a sixth calculation model:

$$\{ \begin{matrix}{r}_{32} = \frac{{r}_{22} {k}_{2} {α}_{22}}{{k}_{3} {α}_{32}} + \frac{{k}_{2}^{2} t {α}_{22}}{2 {k}_{3} {α}_{32}} - \frac{90 ° ( s + c )}{π {α}_{32}} - \frac{{k}_{3} t}{2} \\ {l}_{32} = ( {r}_{32} + {k}_{3} t ) tan \frac{{α}_{32}}{2} + s \\ {β}_{32} = 90 ° - {α}_{32} \\ {h}_{32} = {r}_{32} ( 1 - cos {α}_{32} ) + ( {r}_{32} + {k}_{3} t ) tan \frac{{α}_{32}}{2} \times sin {α}_{32} + s cos {β}_{32} \\ {l}_{3} = 2 ( {r}_{31} + {k}_{3} t ) tan \frac{{α}_{31}}{2} + c\end{matrix} ;$$

where r₂₂ is the arc radius of the second die; α₂₂ is the arc included angle of the second die; α₃₂ is an arc included angle of the third die; s is the inclination length of the third punch and the third die for elongating the metal polar plate; c is the horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is the ratio of the thickness of the metal polar plate after the truing to the thickness of the metal polar plate after the second pre-forming, and 0<k₃<1.

As shown in FIG. 9, a model for calculating a depth h, a width d, a spine width w and a fillet angle r of the flow channel of the metal polar plate is shown as follows:

$$\{ \begin{matrix}r = \frac{{r}_{21} {k}_{2} {α}_{21}}{{k}_{3} {α}_{31}} + \frac{{k}_{2}^{2} t {α}_{21}}{2 {k}_{3} {α}_{31}} - \frac{90 ° ( s + c )}{π {α}_{31}} - \frac{{k}_{3} t}{2} \\ h = r ( 1 - cos {α}_{31} ) + ( r + {k}_{3} t ) tan \frac{{α}_{31}}{2} \times sin {α}_{32} + s cos {β}_{31} \\ w = 2 ( r + {k}_{3} t ) sin {α}_{31} + c \\ d = 2 s sin {β}_{31} + 2 r sin {α}_{31} + c\end{matrix} ;$$

where r₂₁ is the arc radius of the second punch; α₂₁ is half of the arc included angle of the second punch; α₃₁ is half of the arc included angle of the third punch; s is the inclination length of the third punch and the third die for elongating the metal polar plate; c is a horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is the ratio of the thickness of the metal polar plate after the truing to the thickness of the metal polar plate after the second pre-forming, and 0<k₃<1.

A metal anode plate and a metal cathode plate with straight flow channels or S-shaped flow channels can be manufactured by the forming method provided herein.

What is claimed is:

1. A method for forming a flow channel on a metal bipolar plate of a fuel cell, comprising:
pre-treating a metal polar plate;
subjecting the metal polar plate to low-temperature heating;
forming a flow channel on the metal polar plate by rolling;
cutting a gas inlet, a gas outlet, a cooling liquid inlet and a cooling liquid outlet on the metal polar plate;
subjecting the metal polar plate to surface treatment;
bonding the metal polar plate with another metal polar plate treated by the above steps to form a metal bipolar plate; and
trimming the metal bipolar plate;
wherein the step of “forming a flow channel on the metal polar plate by rolling” is performed through steps of:
performing pre-forming twice on the metal polar plate sequentially using a pair of first rollers and a pair of second rollers; and
performing truing once using a pair of truing rollers to form the flow channel on the metal polar plate; and
design parameters of a first punch and a first die of each of the pair of first rollers used in a first pre-forming and design parameters of a second punch and a second die of each of the pair of second rollers used in a second pre-forming are determined through the following steps:
(1) determining an inclination length l₁₁, a draft angle β₁₁ and a depth h₁₁ of the first punch by a first calculation model:
$$\{ \begin{matrix}{l}_{11} = ( {r}_{11} + {k}_{1} t ) tan \frac{{α}_{11}}{2} \\ {β}_{11} = 90 ° - {α}_{11} \\ {h}_{11} = {r}_{11} ( 1 - cos {α}_{11} ) + ( {r}_{11} + {k}_{1} t ) tan \frac{{α}_{11}}{2} \times sin {α}_{11}\end{matrix} ;$$
wherein r₁₁ is an arc radius of the first punch; α₁₁ is half of an arc included angle of the first punch; t is a thickness of the metal polar plate; and k₁ is a ratio of a thickness of the metal polar plate after the first pre-forming to a thickness of the metal polar plate before the first pre-forming, and 0<k₁<1; and
determining an inclination length l₁₂, a draft angle β₁₂, a depth h₁₂ and a horizontal length l₁ of the first die by a second calculation model:
$$\{ \begin{matrix}{l}_{12} = ( {r}_{12} + {k}_{1} t ) tan \frac{{α}_{12}}{2} \\ {β}_{12} = 90 ° - {α}_{12} \\ {h}_{12} = {r}_{12} ( 1 - cos {α}_{12} ) + ( {r}_{12} + {k}_{1} t ) tan \frac{{α}_{12}}{2} \times sin {α}_{12} \\ {l}_{1} = 2 ( {r}_{12} + {k}_{1} t ) tan \frac{{α}_{12}}{2}\end{matrix} ;$$
wherein r₁₂ is an arc radius of the first die; α₁₂ is an arc included angle of the first die; t is the thickness of the metal polar plate; and k₁ is the ratio of the thickness of the metal polar plate after the first pre-forming to the thickness of the metal polar plate before the first pre-forming, and 0<k₁<1; and
(2) determining an inclination length l₂₁, an arc radius r₂₁, a draft angle fill and a depth h₂₁ of the second punch by a third calculation model:
$$\{ \begin{matrix}{r}_{21} = \frac{{k}_{1} {α}_{11}}{{k}_{2} {α}_{21}} \times ( {r}_{11} + \frac{{k}_{1} t}{2} ) - \frac{{k}_{2} t}{2} \\ {l}_{21} = ( {r}_{21} + {k}_{2} t ) tan \frac{{α}_{21}}{2} \\ {β}_{21} = 90 ° - {α}_{21} \\ {h}_{21} = {r}_{21} ( 1 - cos {α}_{21} ) + ( {r}_{21} + {k}_{2} t ) tan \frac{{α}_{21}}{2} \times sin {α}_{21}\end{matrix} ;$$
wherein r₁₁ is the arc radius of the first punch; α₁₁ is half of the arc included angle of the first punch; α₂₁ is half of an arc included angle of the second punch; t is the thickness of the metal polar plate; k₁ is the ratio of the thickness of the metal polar plate after the first pre-forming to the thickness of the metal polar plate before the first pre-forming, and 0<k₁<1; and k₂ is a ratio of a thickness of the metal polar plate after the second pre-forming to the thickness of the metal polar plate after the first pre-forming, and 0<k₂<1; and
determining an inclination length l₂₂, an arc radius r₂₂, a draft angle β₂₂, a depth h₂₂ and a horizontal length l₁ of the second die by a fourth calculation model:
$$\{ \begin{matrix}{r}_{22} = \frac{{k}_{1} {α}_{12}}{{k}_{2} {α}_{22}} \times ( {r}_{12} + \frac{{k}_{1} t}{2} ) - \frac{{k}_{2} t}{2} \\ {l}_{22} = ( {r}_{22} + {k}_{2} t ) tan \frac{{α}_{22}}{2} \\ {β}_{22} = 90 ° - {α}_{22} \\ {h}_{22} = {r}_{22} ( 1 - cos {α}_{22} ) + ( {r}_{22} + {k}_{2} t ) tan \frac{{α}_{22}}{2} \times sin {α}_{22} \\ {l}_{2} = 2 ( {r}_{22} + {k}_{2} t ) tan \frac{{α}_{22}}{2}\end{matrix} ;$$
wherein r₁₂ is the arc radius of the first die; α₁₂ is the arc included angle of the first die; α₂₂ is an arc included angle of the second die; t is the thickness of the metal polar plate; k₁ is the ratio of the thickness of the metal polar plate after the first pre-forming to the thickness of the metal polar plate before the first pre-forming, and 0<k₁<1; and k₂ is the ratio of the thickness of the metal polar plate after the second pre-forming to the thickness of the metal polar plate after the first pre-forming, and 0<k₂<1.

2. The method of claim 1, wherein design parameters of a third punch and a third die of each of the pair of truing rollers are determined through the following steps:
determining an inclination length l₃₁, an arc radius r₃₁, a draft angle β₃₁ and a depth h₃₁ of the third punch by a fifth calculation model:
$$\{ \begin{matrix}{r}_{31} = \frac{{r}_{21} {k}_{2} {α}_{21}}{{k}_{3} {α}_{31}} + \frac{{k}_{2}^{2} t {α}_{21}}{2 {k}_{3} {α}_{31}} - \frac{90 ° ( s + c )}{π {α}_{31}} - \frac{{k}_{3} t}{2} \\ {l}_{31} = ( {r}_{31} + {k}_{3} t ) tan \frac{{α}_{31}}{2} + s \\ {β}_{31} = 90 ° - {α}_{31} \\ {h}_{31} = {r}_{31} ( 1 - cos {α}_{31} ) + ( {r}_{31} + {k}_{3} t ) tan \frac{{α}_{31}}{2} \times sin {α}_{32} + s cos {β}_{31}\end{matrix} ;$$
wherein r₂₁ is the arc radius of the second punch; α₂₁ is half of the arc included angle of the second punch; α₃₁ is half of an arc included angle of the third punch; s is an inclination length of the third punch and the third die for elongating the metal polar plate; c is a horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is a ratio of a thickness of the metal polar plate after the truing to the thickness of the metal polar plate after the second pre-forming, and 0<k₃<1; and
determining an inclination length l₃₂, an arc radius r₃₂, a draft angle β₃₂, a depth h₃₂ and a horizontal length l₃ of the third die by a sixth calculation model:
$$\{ \begin{matrix}{r}_{32} = \frac{{r}_{22} {k}_{2} {α}_{22}}{{k}_{3} {α}_{32}} + \frac{{k}_{2}^{2} t {α}_{22}}{2 {k}_{3} {α}_{32}} - \frac{90 ° ( s + c )}{π {α}_{32}} - \frac{{k}_{3} t}{2} \\ {l}_{32} = ( {r}_{32} + {k}_{3} t ) tan \frac{{α}_{32}}{2} + s \\ {β}_{32} = 90 ° - {α}_{32} \\ {h}_{32} = {r}_{32} ( 1 - cos {α}_{32} ) + ( {r}_{32} + {k}_{3} t ) tan \frac{{α}_{32}}{2} \times sin {α}_{32} + s cos {β}_{32} \\ {l}_{3} = 2 ( {r}_{31} + {k}_{3} t ) tan \frac{{α}_{31}}{2} + c\end{matrix} ;$$
wherein r₂₂ is the arc radius of the second die; α₂₂ is the arc included angle of the second die; α₃₂ is an arc included angle of the third die; s is the inclination length of the third punch and the third die for elongating the metal polar plate; c is the horizontal length of the third punch and the third die for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is the ratio of the thickness of the metal polar plate after the truing to the thickness of the metal polar plate after the second pre-forming, and 0<k₃<1.

3. The method of claim 1, wherein a model for calculating a depth h, a width d, a spine width w and a fillet angle r of the flow channel of the metal polar plate is shown as follows:
$$\{ \begin{matrix}r = \frac{{r}_{21} {k}_{2} {α}_{21}}{{k}_{3} {α}_{31}} + \frac{{k}_{2}^{2} t {α}_{21}}{2 {k}_{3} {α}_{31}} - \frac{90 ° ( s + c )}{π {α}_{31}} - \frac{{k}_{3} t}{2} \\ h = r ( 1 - cos {α}_{31} ) + ( r + {k}_{3} t ) tan \frac{{α}_{31}}{2} \times sin {α}_{32} + s cos {β}_{31} \\ w = 2 ( r + {k}_{3} t ) sin {α}_{31} + c \\ d = 2 s sin {β}_{31} + 2 r sin {α}_{31} + c\end{matrix} ;$$
wherein r₂₁ is the arc radius of the second punch; α₂₁ is half of the arc included angle of the second punch; α₃₁ is half of an arc included angle of a punch of each of the pair of truing rollers; s is an inclination length of the punch and a die of each of the pair of truing rollers for elongating the metal polar plate; c is a horizontal length of the punch and the die of each of the pair of truing rollers for elongating the metal polar plate; t is the thickness of the metal polar plate; k₂ is the ratio of the thickness of the metal polar plate after the second pre-forming to the thickness of the metal polar plate after the first pre-forming, and 0<k₂<1; and k₃ is a ratio of a thickness of the metal polar plate after the truing to the thickness of the metal polar plate after the second pre-forming, and 0<k₃<1.
